(19) United States
(12) Patent Application Publication
(10) Pub. No.: US 2008/0000663 A1
(43) Pub. Date: Jan. 3, 2008

(54) Hammer

(76) Inventor: Stefan Sell, Mainz (DE)

Correspondence Address: Michael P Leary;Patent Counsel, The Black & Decker Corporation, 701 East Joppa Road TW199, Towson, MD, 21286, US

(21) Appl. No.: 11/352,473

(22) Filed: Feb. 10, 2006

(30) Foreign Application Priority Data
Feb. 10, 2005 (GB) GB 05 027 14.9

(51) Int. Cl. B25D 15/02

(52) U.S. Cl. 173/93.6

(57) ABSTRACT

A power tool comprising: a housing 2; a motor mounted within the housing 2; a tool holder 8 rotatably mounted on the housing 2 for holding a cutting tool; at least one striker 612 mounted in a slideable manner within the housing 2 for generating hammering impulses for a cutting tool when a cutting tool is held by the tool holder 8, which striker is capable of being reciprocatingly driven by the motor along an axis of travel in a reciprocating cycle, when the motor is activated, via a drive mechanism; characterised in that the striker 612 is capable of being rotated about a rotational axis which is non coaxial with its axis of travel.

### FIELD OF THE INVENTION

The present invention relates to powered rotary hammers, and to power drills having a hammer action.

### BACKGROUND OF THE INVENTION

Rotary hammers are known in which a motor drives a spindle supporting a hammer bit, while at the same time causing a piston tightly fitted within the spindle to execute linear reciprocating motion within the spindle. This motion causes repeated compression of an air cushion between the piston and a ram slidably mounted within the spindle, which causes the ram in turn to execute reciprocating linear motion within the spindle and apply impacts to the hammer bit via a beat piece.

### BRIEF SUMMARY OF THE INVENTION

Movement of the ram in these types of hammer is limited to a linear motion along its longitudinal axis or a rotational motion about its longitudinal axis.

Accordingly, there is provided a power tool comprising:

a housing;

a motor mounted within the housing;

a tool holder rotatably mounted on the housing for holding a cutting tool;

at least one striker mounted in a slideable manner within the housing for generating hammering impulses for a cuffing tool when a cutting tool is held by the tool holder, which striker is capable of being reciprocatingly driven by the motor along an axis of travel in a reciprocating cycle, when the motor is activated, via a drive mechanism;

characterised in that the striker is capable of being rotated about a rotational axis which is non coaxial with its axis of travel.

### BRIEF DESCRIPTION OF THE DRAWINGS

Two embodiments of the present invention will now be described with reference to the accompanying drawings of which:

FIG. 1 shows a perspective view of a hammer; and

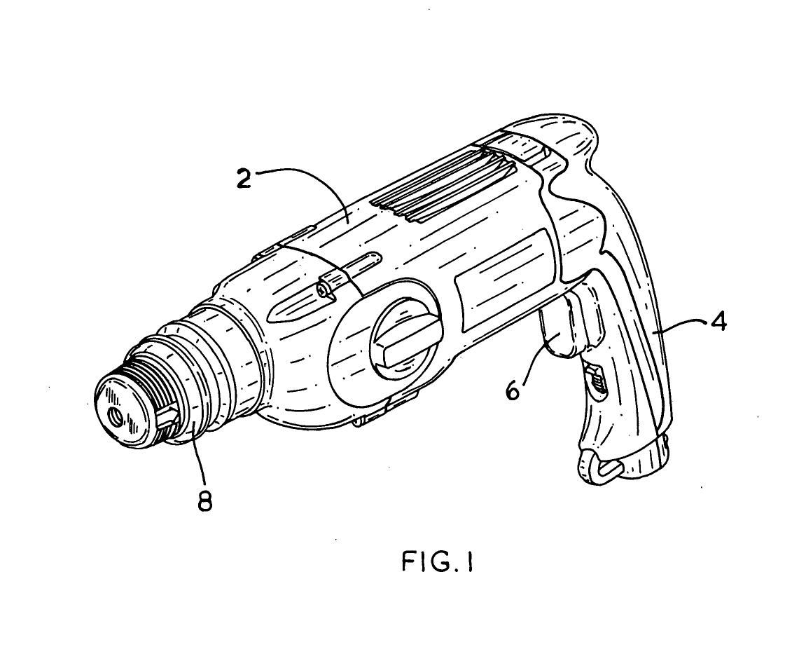

FIG. 2 is an exploded view of a hammer mechanism of a first embodiment of the present invention.

### DETAILED DESCRIPTION OF THE INVENTION

A hammer drill comprises a housing 2 in which is mounted a motor (not shown). A handle 4 is attached to the rear of the housing which can be activated using a trigger switch 6. A tool holder is mounted on the front of the housing 2. The tool holder 8 holds a cutting tool (not shown) such as a drill bit. The motor reciprocatingly drives two bullet shaped impact members 612 which generate hammering impacts for a cutting tool when located within the tool holder in well known manner.

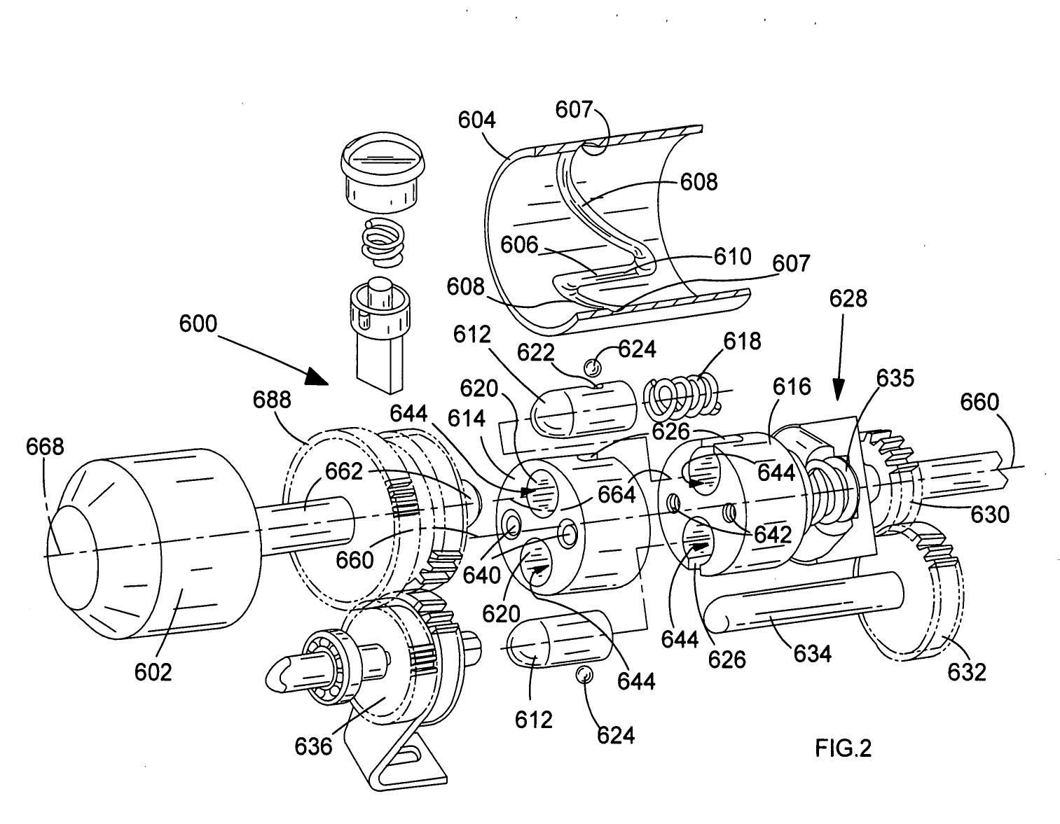

An embodiment of the hammer mechanism 600 invention is shown in FIG. 2, in which axial impacts are imparted to a three-jaw tool holder 602 carrying a drill bit (not shown). The hammer mechanism 600 has a hollow casing 604 (only half of the casing 604 is shown in FIG. 2) fixed relative to the tool housing, the casing 604 having a continuous groove 606 formed around its internal surface which comprises a helical portion 608 and a substantially axial portion 610. The half of the casing 604 which is not shown contains a helical portion 608 only connecting between the ends 607 of the two helical portions 608 on either side of the axial portion 610 on the half of the casing 604 shown in FIG. 2.

First and second cylinders 614, 616 are connected together using screws (not shown) which pass through holes 640 in the first cylinder 614 and screw into threaded holes 642 in the second cylinder. The cylinders 614, 616, when connected together are coaxial and are rotatably, but non axially slidably, mounted within the hollow casing 604.

Formed in each of the cylinders 614, 616 are a pair of tubular recesses 644 having entrances which, when the cylinders 614, 616 are connected together, face towards the other cylinder and which are in alignment with the entrance of a corresponding recess in the other cylinder. The pair of tubular recesses in the first cylinder 614 terminate in apertures 620 formed in the front end of the cylinder 614 which provide access into the recesses from the front of the cylinders 614, 616 when the cylinders are connected together. The diameter of the apertures 620 is smaller than the internal diameter of the recesses 644. Slots 626 are formed in the first and second cylinders 614, 616 which pass through the wall of the cylinders 614, 616 and engage with the recesses 644 within the cylinders 612, 616.

A bullet shaped impact member 612 is located within each of the two sets of recesses together with a compression spring 618 such that each impact member 612 is urged forwardly by their respective compression spring 618 so that its forward portion protrudes through the corresponding aperture 620 in the first cylinder 614. The bullet shaped impact members together with the compression springs are inserted into the cylinders 614, 616 prior to the two cylinders being screwed together to secure them to each other.

Each impact member 612 has a part-spherical recess 622 for receiving a corresponding ball bearing 624 which protrudes through the slot 626 formed in the first and second cylinders 614, 616. As such the bullet shaped impact members can slide within the recesses 644 within the cylinders 614, 616. The ball bearings 624 engage the groove 606 in the casing 604 when the assembled cylinders are located within the casing 604. As a result, rotation of the cylinders 614, 616 about its longitudinal axis 660 relative to the casing 604 causes rearward movement of the impact members 612 relative to the cylinders 614, 616 against the action of the corresponding compression springs 618 due to the ball bearings 624 travelling along the helical portion 608 of the groove 606 until the ball bearings reach an axial part 610 of the groove 606, after which the springs 618 urge the impact members 612 forward along an axis of travel 664 so that its forward end protrudes through the corresponding apertures 620 in the first cylinder 614 to impart an impact on the end of a shaft 662 which supports the tool holder 602. This is achieved due to the location of the axial portion 610 of continuous groove 606 relative to the axis 668 of the shaft 662 which ensures that the axis of travel 664 of the bullet shaped impact member is aligned and co-axial with the axis 668 of rotation of the shaft when the bullet shaped member protrudes through the corresponding aperture 620 in the first cylinder. In addition, as the cylinders rotate, the bullet shaped impact members rotate about the longitudinal axis 660 of the cylinders 614, 616, the longitudinal axis 660 of the cylinders 614, 616 being parallel to the axes of travel of the bullet shaped impact members 612.

The cylinders 614, 616 are rotated relative to the casing 604 by means of a conical clutch 628 engaging a gear 630 which is in turn driven by a gear 632 on a shaft 634 rotated by means of the motor (not shown). The shaft 634 also causes rotation of the tool holder 602 by means of engagement with a gear 636 on shaft 634 with teeth on the external periphery of the gear 638 connect to the tool holder 602.

It will be appreciated by a person skilled in the art that the path of the groove 606 around the internal surface of the casing 604 can be varied in order to generate different types of hammering action. By way of example, the groove 606 may contain two axial parts 610 located directly opposite each other on the internal surface of the casing 604. This would result in the two bullet shaped impact members 612 striking simultaneously, twice every time the first and second cylinders 614, 616 make one complete revolution. The position of the axis of rotation 660 could then be aligned with axis 668 of rotation of the shaft 662 so that the two bullet shaped impact members 612 strike the side of the gear 638 simultaneously, the motion being transferred to the tool holder 602 via the shaft 662.

Though the first and second cylinders 614, 616 can be continually rotated, it will be further appreciated that the first and second cylinders 614, 616 could be held stationary whilst one or both of the bullet shaped members 612 travel along the axial part 610 of the groove 606 due to the biasing force of their respective spring 618, the first and second cylinders 614 then being rotated after the impact, to move the bullet shaped impact members 612 away from the shaft 662 and gear 638 against the biasing force of their respective spring 618 in preparation for the next impact.

A second embodiment of the hammer mechanism will now be described. The construction of the second embodiment is very similar to that of the first embodiment. However, in the second embodiment, the axis 660 of rotation of the first and second cylinders 614, 616 are aligned and co-axial with the axis 668 of rotation of the shaft 662. The first and second cylinders 614, 616 which are rotated in the first embodiment, are held stationary, whilst the hollow casing 604, which is held stationary in the first embodiment relative to the tool housing, is rotated about its longitudinal axis inside the tool housing. This results in the groove 606 rotating around the first and second cylinders 614, 616 causing the bullet shaped impact members to repetitively strike the gear 638 in a manner similar to that described in the first embodiment.

1. A power tool comprising:
a housing 2;
a motor mounted within the housing 2;
a tool holder 8 rotatably mounted on the housing 2 for holding a cutting tool;
at least one striker 612 mounted in a slideable manner within the housing 2 for generating hammering impulses for a cutting tool when a cutting tool is held by the tool holder 8, which striker is capable of being reciprocatingly driven by the motor along an axis of travel 664 in a reciprocating cycle, when the motor is activated, via a drive mechanism; characterised in that the striker 612 is capable of being rotated about a rotational axis 660 which is non coaxial with its axis of travel 664.

2. A power tool as claimed in claim 1 wherein the striker 612 is capable of being rotated about a rotational axis 660 which is parallel to its axis of travel 664.

3. A power tool as claimed in either of claims 1 or 2 wherein the striker 612 is rotated about the rotational axis 660 whilst being reciprocatingly driven by the motor.

4. A power tool as claimed in any one of 1, 2 or 3 wherein during at least one part of its reciprocating cycle, the striker 612 is rotated about the rotational axis, and during at least one other part of the reciprocating cycle, the striker 612 makes no rotational movement about the rotational axis 660.

5. A power tool as claimed in any of claims 1 to 4 wherein the at least one striker 612 is slideably mounted on or within a barrel 614, 616 which is rotatably mounted within the housing.

6. A power tool as claimed in 5 wherein the rotational axis is coaxial with the axis of rotation of the barrel 614, 616.

7. A power tool as claimed in either of claims 5 or 6 wherein the drive mechanism comprises two parts;
a first part comprising the barrel 614, 616;
a second part comprising a sleeve 604 which surrounds at least part of the barrel 614, 616;
the first part being rotatingly driven by the motor within the second part;
wherein the at least one striker 612 comprises a cam 624 co-operatively connected to a cam follower 606 connected to the sleeve 604 so that rotation of first part within the second part results in the striker 612 being driven in at least one direction along its axis of travel over at least part of the reciprocating cycle.

8. A power tool as claimed in either of claims 6 or 7 wherein there is provided biasing means 618 between the barrel 614, 616 and the striker 612 to urge the striker 612 in a predetermined direction along its axis of travel.

9. A power tool as claimed in any of claims 6, 7 or 8 wherein the biasing means 618 drives the striker 612 along its axis of travel over at least a one part of the reciprocating cycle of the striker 612.

10. A power tool as claimed in any one of the previous claims wherein there are at least two strikers 612 which are capable of being reciprocatingly driven along their axes of travel by the motor and which are capable of being rotated about the rotational axis which is non coaxial with either of their axes of travel.

11. A power tool as claimed in claim 10 wherein the two strikers 612 are located adjacent each other.

12. A power tool as claimed in any one of claims 10 or 11 wherein the axes of travel of the strikers 612 are parallel.

13. A power tool as claimed in any one of claims 12, 13 or 14 wherein the strikers 612 are reciprocatingly driven simultaneously.

14. A power tool as claimed in any one of claims 10 to 13 wherein at least two of the strikers 612 impact an anvil 662; 638 at the same location.

15. A power tool as claimed in any one of claims 10 to 14 wherein at least two of the strikers 612 impact an anvil 662; 638 simultaneously.

16. A power tool as claimed in any one of claims 5 to 9 or claims 10 to 15 when dependent on claims 5 to 9, wherein the barrel 614, 616 comprises at least one chamber 644 in which is located a striker 612, the chamber 644 having at least one aperture 620 through which a part of the striker 612 can pass in order to strike an anvil 638 and a second aperture 626 through which the cam 624 can pass to engage with cam follower 606.

17. A power tool as claimed in claim 17 wherein the barrel 614, 616 comprises two sections which are capable of being attached to each other, part of the chamber 644 being formed in one section, the rest of the chamber 644 being formed in the other section, the chamber 644 being formed when the two sections 614, 616 are attached to each other.
